(19) United States
(12) Patent Application Publication
(10) Pub. No.: US 2022/0416603 A1
(43) Pub. Date: Dec. 29, 2022

(54) MOTOR AND DISK DRIVE DEVICE

(71) Applicant: Nidec Corporation, Kyoto (JP)

(72) Inventors: Ryo MIYOSHI, Kyoto (JP); Kazuhiro SATO, Kyoto (JP); Toshihiro AKIYAMA, Kyoto (JP)

(21) Appl. No.: 17/844,789

(22) Filed: Jun. 21, 2022

(30) Foreign Application Priority Data
Jun. 25, 2021 (JP) 2021-106006

(51) Int. Cl. H02K 1/30; H02K 7/08; H02K 21/22; G11B 19/20

(52) U.S. Cl. CPC H02K 1/30; H02K 7/085; H02K 21/22; G11B 19/2027

(57) ABSTRACT

A rotor includes a rotor hub including a through-hole to which the shaft is fixed. An upper end and a lower end of an opposing region where an outer peripheral surface of the shaft and an inner peripheral surface of the through-hole oppose each other in a radial direction are respectively provided with an upper gap portion and a lower gap portion opposing each other through a space in the radial direction. The upper gap portion and the lower gap portion each include a bottom portion extending in a direction intersecting the center axis and a peripheral wall portion connected to a radial outer edge of the bottom portion and extending along the center axis.

### CROSS-REFERENCE TO RELATED APPLICATIONS

The present invention claims priority under 35 U.S.C. § 119 to Japanese Patent Application No. 2021-106006, filed on Jun. 25, 2021, the entire contents of which are hereby incorporated herein by reference.

### 1. FIELD OF THE INVENTION

The present disclosure relates to a motor and a disk drive device using the motor.

### 2. BACKGROUND

Conventionally, a rotary driver is known. In this type of rotary driver, a hub is press-fitted into an end portion of a shaft rotatably supported by a dynamic pressure bearing mechanism fixed to a chassis. The rotary driver includes a coil formed on a stator core attached to the chassis and a magnet attached to the hub through a yoke and rotates the hub by the magnetic force generated between the coil and the magnet.

The shaft is press-fitted into an opening formed in the hub. A portion where the hub and the opening are in contact with each other is secured to the full thickness of the hub to increase the fastening strength between the shaft and the hub.

In the conventional rotary driver, when an external force due to an impact, vibration, or the like acts on the hub, a force in a direction away from the shaft acts on the upper end and the lower end of the hub. When the upper end and the lower end of the hub are plastically deformed by this force, fastening between the hub and the shaft becomes unstable, and there is a possibility that the hub periodically swings during rotation, that is, so-called repeatable run-out (RRO) occurs.

### SUMMARY

A motor according to an example embodiment of the present disclosure includes a shaft that extends along a center axis extending vertically and is rotatable around the center axis, a rotor fixed to the shaft, a bearing portion that rotatably supports the shaft, and a stator radially facing the rotor. The rotor includes a rotor hub including a through-hole to which the shaft is fixed. An upper end and a lower end of an opposing region where an outer peripheral surface of the shaft and an inner peripheral surface of the through-hole oppose each other in a radial direction are respectively provided with an upper gap portion and a lower gap portion opposing each other through a space in the radial direction. The upper gap portion and the lower gap portion each include a bottom portion extending in a direction intersecting the center axis and a peripheral wall portion connected to a radial outer edge of the bottom portion and extending along the center axis.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is an exploded perspective view of a motor according to an example embodiment of the present disclosure.

FIG. 2 is a sectional view of the motor illustrated in FIG. 1 taken along a plane including a center axis.

FIG. 3 is an enlarged sectional view of an opposing region where the outer peripheral surface of the shaft and the inner peripheral surface of the rotor oppose each other.

FIG. 4 is an enlarged sectional view of a motor according to a first modification of an example embodiment of the present disclosure.

FIG. 5 is an enlarged sectional view of a motor according to a second modification of an example embodiment of the present disclosure.

FIG. 6 is an enlarged sectional view of a motor according to a third modification of an example embodiment of the present disclosure.

FIG. 7 is an enlarged sectional view of a motor according to a fourth modification of an example embodiment of the present disclosure.

FIG. 8 is an enlarged sectional view of a motor according to a fifth modification of an example embodiment of the present disclosure.

FIG. 9 is an enlarged sectional view of a motor according to a sixth modification of an example embodiment of the present disclosure.

### DETAILED DESCRIPTION

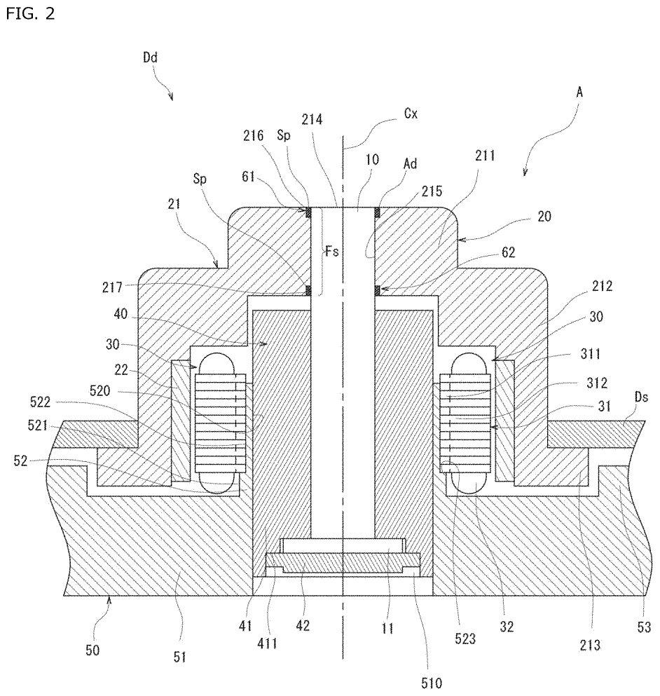

Example embodiments of the present disclosure will be described in detail with reference to the drawings. In the present specification, a direction parallel to the center axis Cx of a motor is referred to by the term “axial direction”, a direction perpendicular to the center axis Cx is referred to by the term “radial direction”, and a direction along an arc about the center axis Cx is referred to by the term “circumferential direction”. In this specification, “upper” and “lower” are defined along the center axis Cx with reference to a motor A illustrated in FIG. 2, and the shapes of components and their positional relationship will be described. The vertical direction is a name used simply for the sake of the description, and does not limit the positional relationship and direction of the motor in use.

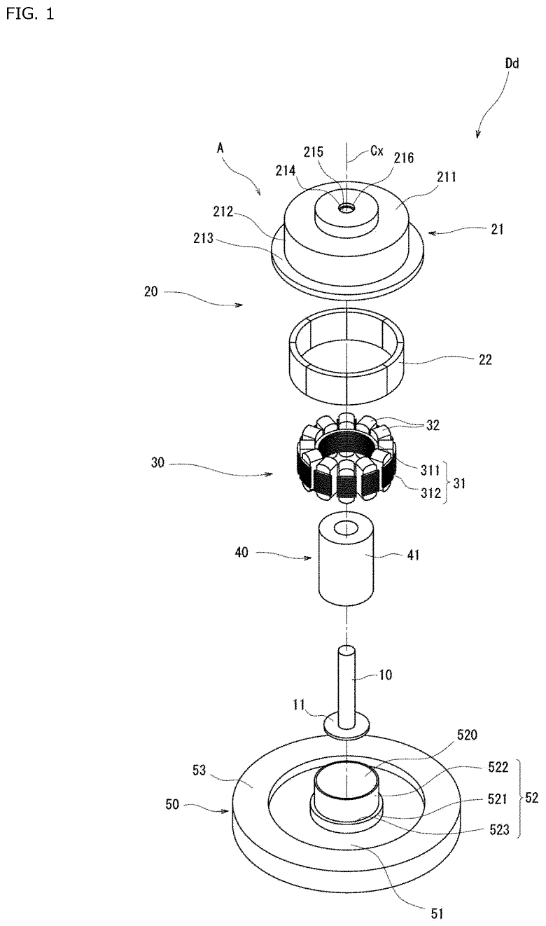

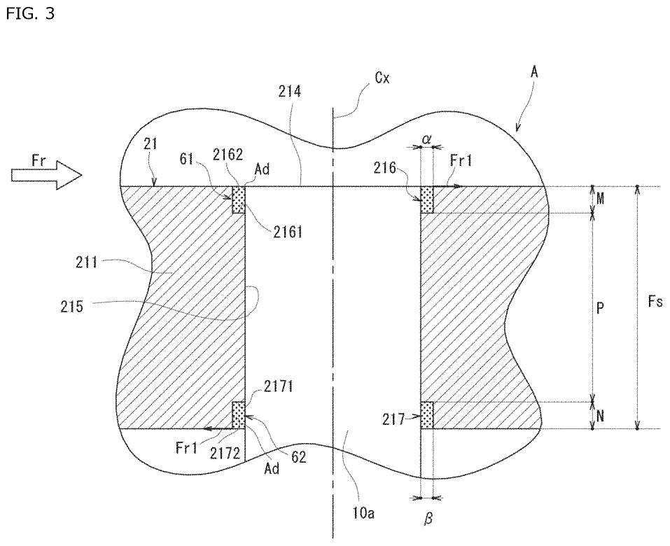

Example embodiments of the present disclosure will be described with reference to the accompanying drawings. FIG. 1 is an exploded perspective view of a motor according to an example embodiment of the present disclosure. FIG. 2 is a sectional view of the motor illustrated in FIG. 1 taken along a plane including a center axis. FIG. 3 is an enlarged sectional view of an opposing region Fs where the outer peripheral surface of a shaft 10 and the inner peripheral surface of a rotor 20 oppose each other.

The motor A is used for a disk drive device Dd that drives a disk-shaped data recording disk Ds such as a hard disk. The motor A is a spindle motor. As illustrated in FIGS. 1 and 2, the motor A includes the shaft 10, the rotor 20, a stator 30, a bearing portion 40, and a base portion 50. The respective components of the motor A will be described below in detail.

As illustrated in FIGS. 1 and 2, the base portion 50 is disposed at the axial lower end of the motor A. The base portion 50 includes a base plate 51, an inner cylindrical portion 52, and an outer cylindrical portion 53. The base plate 51 has an annular shape when viewed from the axial direction. More specifically, the base plate 51 has an annular shape and a through-hole 510 penetrating the central portion in the axial direction when viewed from the axial direction. In the motor A according to the present example embodiment, the base plate 51 has an annular shape but is not limited thereto.

The inner cylindrical portion 52 extends upward along the center axis Cx from the peripheral portion of the through-hole 510 of the base plate 51. The inner cylindrical portion 52 has a first outer peripheral surface 521, a second outer peripheral surface 522, and a coupling surface 523. The first outer peripheral surface 521 protrudes upward along the center axis Cx from the upper surface of the base plate 51. The second outer peripheral surface 522 protrudes upward along the center axis Cx from the axial upper end of the first outer peripheral surface 521.

The second outer peripheral surface 522 has an outer diameter smaller than that of the first outer peripheral surface 521. The coupling surface 523 is a plane orthogonal to the center axis Cx. The coupling surface 523 connects the upper end of the first outer peripheral surface 521 and the lower end of the second outer peripheral surface 522. A cross section orthogonal to the central axis Cx of the inner peripheral surface 520 is a cylindrical surface that is uniform over the entire length. A stator core 31 (to be described later) of a stator 30 is fixed to the second outer peripheral surface 522.

The outer cylindrical portion 53 extends upward along the center axis Cx from the radial outer edge of the base plate 51. In the motor A, the outer cylindrical portion 53 has a cylindrical shape but is not limited thereto. In the motor A, the lower end portion of a rotor hub 21 (to be described later) of the rotor 20 rotates inside the outer cylindrical portion 53. Accordingly, the shape of the outer peripheral surface of the outer cylindrical portion 53 is not particularly limited, but the inner peripheral surface is preferably cylindrical.

The bearing portion 40 is fixed to the inner peripheral surface 520 of the inner cylindrical portion 52 of the base plate 51. The bearing portion 40 rotatably supports the shaft 10. The bearing portion 40 includes a sleeve portion 41 and a seal portion (see FIG. 2). The sleeve portion 41 has a cylindrical shape centered on the central axis Cx. In the motor A, the sleeve portion 41 has a cylindrical shape, and the center thereof overlaps the center axis Cx. The sleeve portion 41 is disposed inside the inner cylindrical portion 52. The sleeve portion 41 is fixed to the inner peripheral surface 520 of the inner cylindrical portion 52 by a fixing method such as press fitting. The fixing method for the sleeve portion 41 is not limited to press-fitting, and a fixing method such as bonding and welding may be adopted.

The shaft 10 is disposed inside the sleeve portion 41. More specifically, the shaft 10 penetrates the sleeve portion 41, and the upper end portion is disposed so as to protrude upward from the upper end of the sleeve portion 41. The sleeve portion 41 has a recess 411 recessed upward on the lower end surface. The recess 411 has a columnar shape overlapping the center axis Cx. A flange portion 11 (to be described later) of the shaft 10 is accommodated in the recess 411.

The seal portion 42 is disposed below the sleeve portion 41 of the inner cylindrical portion 52 of the base plate 51. The seal portion 42 is fixed to the inner peripheral surface 520 of the inner cylindrical portion 52 by a fixing method such as press fitting. The seal portion 42 is used to suppress leakage of a lubricating oil described later. Accordingly, the outer peripheral surface of the seal portion 42 and the inner peripheral surface 520 of the inner cylindrical portion 52 are in close contact with each other to such an extent that the lubricating oil does not pass therethrough. It is possible to widely adopt a fixing method capable of maintaining the above-described tight state between the outer peripheral surface of the seal portion 42 and the inner peripheral surface 520 of the inner cylindrical portion 52.

Gaps are respectively provided between the inner peripheral surface of the sleeve portion 41 and the outer peripheral surface of the shaft 10, between the sleeve portion 41 and the upper surface and the outer peripheral surface of the flange portion 11, and between the upper surface of the seal portion 42 and the lower surface of the flange portion 11. These gaps are continuously filled with a lubricating oil as a fluid. In the motor A, the sleeve portion 41, the seal portion 42, the shaft 10, and the lubricating oil constitute the bearing portion 40.

In the bearing portion 40, a radial groove (not illustrated) is formed in a portion facing the sleeve portion 41 on the outer peripheral surface of the shaft 10. When the shaft 10 rotates, dynamic pressure is generated in the lubricating oil by the radial groove, and the lubricating oil flows by the dynamic pressure. The outer peripheral surface of the shaft 10 and the inner peripheral surface of the sleeve portion 41 are then maintained at a predetermined interval by the dynamic pressure of the lubricating oil. As the lubricating oil circulates, the shaft rotates while maintaining a constant gap between the outer peripheral surface and the inner peripheral surface of the sleeve portion 41. That is, the shaft 10 is rotatably supported in the circumferential direction.

More specifically, the outer peripheral surface of the shaft 10, the inner peripheral surface of the sleeve portion 41, and the lubricating oil flowing through the gap constitute a so-called radial bearing that supports the shaft 10 in the circumferential direction.

The radial grooves are provided at two places separated from each other in the axial direction. As a result, the shaft 10 is supported by the sleeve portion 41 at two places separated in the axial direction. This prevents the shaft 10 from inclining with respect to the center axis Cx during rotation, that is, from swinging and rotating. The number of radial grooves is not limited to two and may be three or more. Further, the radial grooves are not limited to the outer peripheral surface of the shaft 10 and may be formed on the inner peripheral surface of the sleeve portion 41.

A thrust groove (not illustrated) is formed on the upper surface of the flange portion 11. When the shaft 10 rotates, dynamic pressure is generated in the lubricating oil by the thrust groove, and the lubricating oil flows by the dynamic pressure. The dynamic pressure of the lubricating oil maintains the upper surface of the flange portion 11 and the bottom surface of the recess 411 at a predetermined interval.

A thrust groove (not illustrated) similar to the above-described thrust groove is formed on the upper surface of the seal portion 42, that is, the surface facing the lower surface of the flange portion 11. When the shaft 10 rotates, dynamic pressure is generated in the lubricating oil by the thrust groove. The dynamic pressure of the lubricating oil then maintains the lower surface of the flange portion 11 and the upper surface of the seal portion 42 at a predetermined interval.

More specifically, the recess 411 of the sleeve portion 41, the flange portion 11, and the gap therebetween, the flange portion 11, the seal portion 42, and the gap therebetween, the axial lower surface of the sleeve portion 41 and a hub top plate portion 211, and the gap therebetween constitute a so-called thrust bearing, which axially supports the shaft 10 by a lubricating oil flowing through the gaps. The thrust groove for forming the thrust bearing between the flange portion 11 and the recess 411 is not limited to the upper surface of the flange portion 11 and may be formed on the lower surface of the recess 411. The thrust groove for forming the thrust bearing between the flange portion 11 and the seal portion 42 is not limited to the upper surface of the seal portion 42 and may be formed on the lower surface of the flange portion 11.

As described above, the shaft 10 is rotatably supported by the bearing portion 40 by the lubricating oil interposed between the sleeve portion 41 and the shaft 10.

Referring to FIGS. 1 and 2, the shaft 10 is columnar. The shaft 10 is made of a metal, and its center coincides with the center axis Cx. The shaft 10 rotates about the center axis Cx. That is, the shaft 10 is disposed along the center axis Cx extending vertically and rotates around the center axis Cx. The flange portion 11 is disposed at the lower end portion of the shaft 10. The flange portion 11 expands radially outward. The flange portion 11 has a disk shape. The flange portion 11 is integrally molded with the shaft 10. The flange portion 11 may be formed separately from the shaft 10 and fixed to the shaft 10.

As described above, a radial groove that generates dynamic pressure of a lubricating oil by rotation, for example, a herringbone groove, is formed on the outer peripheral surface of the shaft 10. A thrust groove that generates dynamic pressure of a lubricating oil by rotation is formed on the upper surface of the flange portion 11.

The rotor 20 is fixed to the shaft 10. That is, the rotor rotates integrally with the shaft 10. The rotor 20 includes a rotor hub 21 and a rotor magnet 22. The rotor hub 21 includes a hub top plate portion 211, a hub cylindrical portion 212, a disk flange portion 213, and a through-hole 214.

The hub top plate portion 211 is arranged to extend radially. The hub top plate portion 211 is circular when viewed in the axial direction. The hub cylindrical portion 212 is cylindrical. The hub cylindrical portion 212 is arranged to extend axially downward from a radial outer edge of the hub top plate portion 211. The disk flange portion 213 is arranged to extend radially outward from an axial lower end portion of the hub cylindrical portion 212. The disk flange portion 213 is circular when viewed in the axial direction. The hub top plate portion 211, the hub cylindrical portion 212, and the disk flange portion 213 are made of the same member and are molded integrally with each other.

An axial upper surface of the disk flange portion 213 is a flat surface perpendicular to the center axis Cx. The axial upper surface of the disk flange portion 213 is disposed in contact with the lower surface of the data recording disk Ds. That is, disk flange portion 213 is a disk support that supports the disk Ds. At this time, a fixing member (not illustrated) is fixed to the upper surface of the data recording disk Ds. With this operation, the data recording disk Ds is fixed perpendicular to the central axis Cx. The data recording disk Ds also rotates by the rotation of the rotor 20.

In the motor A according to the present example embodiment, one data recording disk Ds is fixed, but the present disclosure is not limited thereto, and a plurality of data recording disks Ds may be fixed at intervals in the center axis Cx direction. Even in this configuration, all the data recording disks Ds are fixed in a state of being orthogonal to the center axis Cx.

The through-hole 214 is formed at the center of the hub top plate portion 211 as viewed in the axial direction. The through-hole 214 penetrates in the axial direction. The shaft 10 is inserted into the through-hole 214. The shaft 10 is fixed to a shaft fixing portion 215 (to be described later) of the through-hole 214. That is, the rotor 20 includes the rotor hub 21 having the through-hole 214 to which the shaft 10 is fixed.

In the rotor 20, a region where the outer peripheral surface of the shaft 10 and the inner peripheral surface of the through-hole 214 oppose each other in the radial direction is the opposing region Fs. In the motor A, an upper gap portion 61 and a lower gap portion 62 opposing each other through a space Sp in the radial direction are formed at the upper end and the lower end of the opposing region Fs. That is, the upper end and the lower end of the opposing region Fs where the outer peripheral surface of the shaft 10 and the inner peripheral surface of the through-hole 214 oppose each other in the radial direction are respectively provided with the upper gap portion 61 and the lower gap portion 62 opposing each other through the space Sp in the radial direction.

The through-hole 214 includes a shaft fixing portion 215, an upper recess 216, and a lower recess 217. The shaft fixing portion 215 is disposed at the axial center of the through-hole 214.

The shaft fixing portion 215 is a cylindrical through-hole, and the center thereof coincides with the center axis Cx. The shaft 10 is fixed to the shaft fixing portion 215. The shaft 10 is fixed to the shaft fixing portion 215 by, for example, press fitting. By fixing the shaft 10 to the shaft fixing portion 215, the rotor 20 and the shaft 10 are fixed. A method of fixing the shaft 10 to the shaft fixing portion 215 is not limited to press-fitting, and a fixing method capable of firmly fixing the shaft 10 to the rotor hub 21, such as bonding and welding, can be widely adopted. In the present example embodiment, the inner diameter of the shaft fixing portion 215 is substantially the same as the outer diameter of the shaft 10.

As illustrated in FIG. 1 and the like, the upper recess 216 is disposed at the upper end portion of the through-hole 214, and the lower recess 217 is disposed at the lower end portion of the through-hole 214. The upper recess 216 is connected to the upper end of the shaft fixing portion 215. The upper recess 216 has a cylindrical shape whose center coincides with the center axis Cx. The inner diameter of the upper recess 216 is larger than the inner diameter of the shaft fixing portion 215. The upper recess 216 has a bottom portion 2161 and a peripheral wall portion 2162. The peripheral wall portion 2162 has a tubular shape centered on the center axis Cx.

The bottom portion 2161 has a planar shape extending in a direction intersecting the center axis Cx. The bottom portion 2161 has an annular shape, the radial inner edge is connected to the shaft fixing portion 215, and the radial outer end is connected to the peripheral wall portion 2162.

When the shaft 10 is fixed to the shaft fixing portion 215, the upper end of the shaft 10 reaches the upper end of the rotor hub 21. In this case, that the upper end of the shaft 10 reaches the upper end of the rotor hub 21 includes a case where the upper end surface of the shaft is disposed in a single plane with the upper end surface of the rotor hub 21, and also includes a case where the upper end surface is slightly shifted up and down.

As illustrated in FIG. 1 and the like, the lower recess 217 is connected to the lower end of the shaft fixing portion 215. The lower recess 217 has a cylindrical shape whose center coincides with the center axis Cx. The inner diameter of the lower recess 217 is larger than the inner diameter of the shaft fixing portion 215. The lower recess 217 has a bottom portion 2171 and a peripheral wall portion 2172. The peripheral wall portion 2172 has a tubular shape centered on the center axis Cx.

That is, the upper gap portion 61 and the lower gap portion 62 have bottom portions 2161 and 2171 extending in a direction intersecting the center axis Cx, and peripheral wall portions 2162 and 2172 connected to radial outer edges of the bottom portions 2161 and 2171 and extending along the center axis Cx.

That is, the bottom portions 2161 and 2171 and the peripheral wall portions 2162 and 2172 of at least one of the upper gap portion 61 and the lower gap portion 62 are formed in the rotor hub 21. In this manner, the bottom portions 2161 and 2171 and the peripheral wall portions 2162 and 2172 can be easily formed in the rotor hub 21.

The bottom portion 2171 has a planar shape extending in a direction intersecting the center axis Cx. The bottom portion 2171 has an annular shape, the radial inner edge is connected to the shaft fixing portion 215, and the radial outer end is connected to the peripheral wall portion 2172.

The shaft 10 is fixed to the rotor hub 21 of the rotor 20. At this time, the space Sp is formed between the peripheral wall portion 2162 of the upper recess 216 and the outer peripheral surface of the shaft 10. As a result, the upper gap portion 61 is formed at the upper end of the opposing region Fs. The space Sp is formed between the peripheral wall portion 2172 of the lower recess 217 and the outer peripheral surface of the shaft 10. As a result, the lower gap portion 62 is formed at the lower end of the opposing region Fs.

The upper gap portion 61 and the lower gap portion 62 are filled with an adhesive Ad. Any one of the upper gap portion 61 and the lower gap portion 62 may be filled with the adhesive. That is, at least one of the upper gap portion 61 and the lower gap portion 62 is filled with the adhesive.

In this manner, the shaft 10 and the rotor hub 21 can be firmly fixed by being filled with the adhesive Ad.

By fixing at least one of the upper end and the lower end of the opposing region Fs between the shaft 10 and the rotor hub 21 with an adhesive, the shaft 10 and the rotor hub 21 can be firmly fixed. Furthermore, since the upper gap portion 61 and the lower gap portion 62 can be filled with the adhesive Ad, it is possible to suppress the adhesive Ad from leaking from the axial upper end and the axial lower end to the outside.

For example, the adhesive Ad may be a material having a smaller elastic coefficient than the shaft 10 and the rotor hub 21, that is, a material that is easily deformed. In this manner, when a force Fr in the direction intersecting the center axis Cx acts due to impact, vibration, or the like, the adhesive Ad acts as a cushion, and plastic deformation of the upper end and the lower end of the fastening portion of the rotor hub 21 to the shaft 10 can be suppressed.

As illustrated in FIG. 3, the axial length of the upper gap portion 61 is defined as a length M, the axial length of the lower gap portion 62 is defined as a length N, and the axial length of the shaft fixing portion 215 is defined as a length P. In this case, the opposing region Fs is formed such that inequality 1 holds.

P>M+N (1)

That is, the sum of the axial length M of the upper gap portion 61 and the axial length N of the lower gap portion 62 is smaller than the length obtained by subtracting the axial length M of the upper gap portion 61 and the axial length N of the lower gap portion 62 of the opposing region Fs from the length of the opposing region Fs.

By enlarging the fastening portion of the central portion of the opposing region Fs, the shaft 10 and the rotor hub 21 can be firmly fixed. In addition, when the force Fr due to impact, vibration, or the like is applied in the direction intersecting the center axis Cx, stress concentrates on the upper end and the lower end of the opposing region Fs. At this time, since the radial spaces Sp are provided at the upper end and the lower end of the opposing region Fs where stress is concentrated, plastic deformation due to the force Fr is less likely to occur on the rotor hub 21. Therefore, it is possible to suppress an increase in repeatable run-out (RRO) generated in synchronization with the rotation of the shaft 10.

As illustrated in FIG. 3, the radial length of the bottom portion 2161 of the upper gap portion 61 is defined as a length α, and the radial length of the bottom portion 2171 of the lower gap portion 62 is defined as a length β. The upper gap portion 61 and the lower gap portion 62 are formed so as to satisfy inequalities 2 and 3.

M>α (2)

N>β (3)

That is, the radial length α of the upper end of the upper gap portion 61 is shorter than the axial length M of the upper gap portion 61. The radial length β of the upper end of the lower gap portion 62 is shorter than the axial length N of the lower gap portion 62.

With such a configuration, the rotor hub 21 can be firmly fixed to the shaft 10. In this way, it is possible to suppress the filling amount of the adhesive Ad to be small and to firmly fix the rotor hub 21 and the shaft 10. In addition, the protrusion of the adhesive can be suppressed by making the upper gap portion 61 and the lower gap portion 62 deep.

Furthermore, the radial length α of the upper gap portion 61 and the radial length β of the lower gap portion 62 may be the same, or one of them may be larger than the other.

Only one of the upper gap portion 61 and the lower gap portion 62 may be filled with the adhesive Ad. Furthermore, when the shaft 10 can be firmly fixed only by the shaft fixing portion 215, the adhesive Ad may not be applied.

Referring to FIG. 2, the rotor magnet 22 is placed on the inner surface of the hub cylindrical portion 212. The rotor magnet 22 is cylindrical and is placed to extend along the center axis Cx. The inner surface of the rotor magnet 22 faces the outer peripheral surface of the stator core 31 of the stator 30 with a gap in the radial direction. The rotor magnet 22 may be defined by a cylindrical magnetic body including north and south poles arranged to alternate with each other in a circumferential direction, or alternatively, a plurality of magnets arranged in the circumferential direction may be used as the rotor magnet 22. The rotor magnet 22 is fixed inside of the hub cylindrical portion 212 through, for example, press fitting. Note that the method for fixing the rotor magnet 22 is not limited to the press fitting, and that adhesion, welding, a mechanical fixing method, and so on may be adopted to fix the rotor magnet 22.

The stator 30 is fixed to a second outer peripheral surface 522 of the inner cylindrical portion 52 of the base portion 50. The stator 30 radially faces the rotor 20. The stator 30 includes the stator core 31 and the coil portion 32. The stator core 31 is defined by laminated silicon steel sheets. Referring to FIG. 1, the stator core 31 includes an annular core back 311 and teeth 312.

The core back 311 is annular, and is arranged to extend in the axial direction. The inner surface of the core back 311 is fixed to the second outer peripheral surface 522 of the inner cylindrical portion 52 of the base portion 50. The core back 311 is fixed to the inner cylindrical portion 52 by press-fitting. In addition to this, a fixing method that can firmly fix the inner cylindrical portion 52 and the core back 311, such as bonding, fusion bonding, and welding, can be widely adopted.

The teeth 312 protrude radially outward from an outer peripheral surface of the core back 311. The teeth 312 are arranged at regular intervals in the circumferential direction. An insulator (not illustrated) having an insulating property is attached to at least the teeth 312 of the stator 30, and a conductive wire is wound around the insulator from above. The coil portion 32 is formed by winding a conductive wire around each of the teeth 312 of the stator core 31.

The motor A according to the present example embodiment has the above-described configuration. The force acting at the time of the operation of the motor A according to the present example embodiment will be described next. Referring to FIG. 3, the force Fr acting on the rotor 20 by an impact, vibration, or the like acting on the motor A is indicated by an arrow.

A force in a direction intersecting with the center axis Cx sometimes acts on the rotor 20 of the motor A. For example, referring to FIG. 3, consider a case where the force Fr acts on the rotor 20 from the left to the right. At this time, a force Fri as illustrated in FIG. 3 acts on the opposing region Fs that is a connection portion between the shaft 10 and the rotor hub 21. More specifically, one end of the shaft 10 is supported by the bearing portion 40. Therefore, when the force Fr acts, a moment in the clockwise direction acts on the opposing region Fs in the state illustrated in FIG. 3.

When a moment in the clockwise direction acts on the opposing region Fs in the motor A illustrated in FIG. 3, the force Fri in a direction separating from the shaft 10 acts on one end in a direction parallel to the force Fr on the rotor hub 21 at the upper end and the lower end of the opposing region Fs.

As described above, the upper gap portion 61 and the lower gap portion 62 are filled with the adhesive Ad. Accordingly, the adhesive Ad having an elastic coefficient smaller than those of the shaft 10 and the rotor hub 21 is deformed by the force Fri in the direction to peel off from the shaft 10 acting on the rotor hub 21. This makes it possible to suppress plastic deformation of the rotor hub 21. As a result, it is possible to suppress repeatable run-out (RRO) synchronized with the rotation of the rotor 20 of the rotor hub 21.

When the upper gap portion 61 and the lower gap portion are not filled with the adhesive Ad, the rotor hub 21 is separated from the shaft 10 at the upper end and the lower end of the opposing region Fs. No force for fixing to the shaft 10 is applied to the rotor hub 21 at the upper end and the lower end of the opposing region Fs. Therefore, even when the force Fri acts on the rotor hub 21, plastic deformation of the rotor hub 21 is suppressed.

It is possible to suppress repeatable run-out (RRO) synchronized with the shaft 10 and the rotor 20 which occurs when the rotor hub 21 is plastically deformed. That is, in the motor A according to the present example embodiment, the upper gap portion 61 and the lower gap portion 62 are provided at the upper end and the lower end of the opposing region Fs, respectively, thereby suppressing plastic deformation of the rotor hub 21. This makes it possible to suppress the periodic vibration and to enhance the rotation accuracy of the motor A. As a result, the data recording disk Ds fixed to the rotor hub 21 can be rotated with high accuracy.

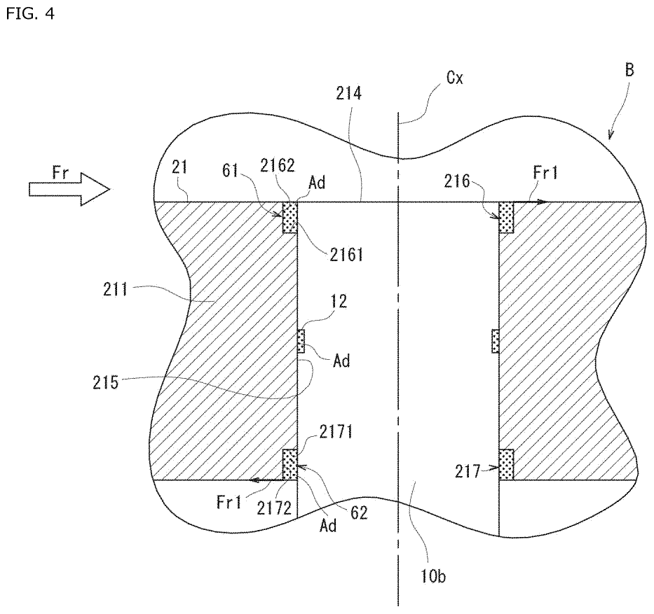

FIG. 4 is an enlarged sectional view of a motor B according to the first modification. The motor B illustrated in FIG. 4 is different from the motor A illustrated in FIG. 2 and the like in that a shaft 10b has a peripheral groove 12 filled with the adhesive Ad. In other respects, the motor B has substantially the same configuration as the motor A. Thus, a portion of the motor B which is substantially the same as that of the motor A is denoted by the same reference numeral, and duplicated detailed description of substantially the same portion will be eliminated.

As illustrated in FIG. 4, the shaft 10b has the peripheral groove 12 recessed radially inward in a portion radially facing the shaft fixing portion 215 on the outer peripheral surface. That is, at least one peripheral groove 12 continuous in the circumferential direction is formed on the outer peripheral surface of the shaft 10 below the upper gap portion 61 and above the lower gap portion 62 in the opposing region Fs. The peripheral groove 12 is continuous with the outer peripheral surface of the shaft 10b in the circumferential direction. The peripheral groove 12 is filled with the adhesive Ad.

In the present modification, one peripheral groove 12 is formed on the outer peripheral surface of the shaft 10b, but the present disclosure is not limited thereto. The plurality of peripheral grooves 12 may be formed apart in the axial direction. Although the peripheral groove 12 is formed on the outer peripheral surface of the shaft 10b, the present disclosure is not limited thereto, and a peripheral groove recessed radially outward may be formed on the inner peripheral surface of the through-hole 214 of the rotor hub 21.

By having the peripheral groove 12 filled with the adhesive Ad, the shaft 10b and the rotor hub 21 can be more firmly fixed. In addition, since the contact area between the shaft 10b and the rotor hub 21 in the opposing region Fs can be reduced, the press-fitting force when the shaft 10b is press-fitted into the rotor hub 21 can be reduced. This can suppress the deformation of the shaft 10b due to the load at the time of press-fitting and reduce the repeatable run-out (RRO) due to the deformation of the shaft 10b.

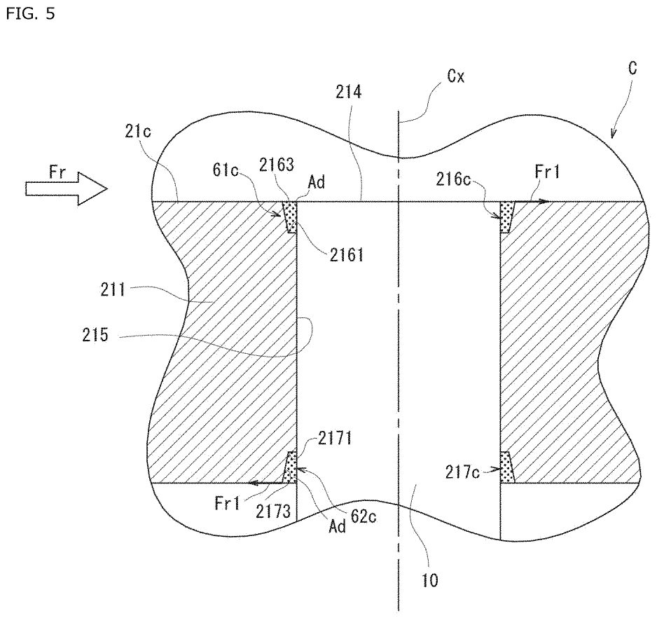

FIG. 5 is an enlarged sectional view of a motor C according to the second modification. In the motor C illustrated in FIG. 5, a peripheral wall portion 2163 of an upper gap portion 61c and a peripheral wall portion 2173 of a lower gap portion 62c are different from the peripheral wall portion 2162 of the upper gap portion 61 and the peripheral wall portion 2172 of the lower gap portion 62 of the motor A illustrated in FIG. 3 and the like. Regarding other points of the motor C, the motor C has the same configuration as that of the motor A illustrated in FIG. 3 and the like. Accordingly, a portion of the motor C which is substantially the same as that of the motor A is denoted by the same reference numeral, and duplicated detailed description of substantially the same portion will be eliminated.

As illustrated in FIG. 5, the peripheral wall portion 2163 of an upper recess 216c expands radially outward as proceeding axially upward. That is, the peripheral wall portion 2163 of the upper gap portion 61c has a tapered shape extending in a direction away from the contact surface between the shaft 10 and the through-hole 214 as proceeding axially upward. The peripheral wall portion 2163 has a tapered shape expanding axially upward. Since the upper end of the peripheral wall portion 2163 is distant from the contact surface between the shaft 10 and the through-hole 214, it is possible to suppress plastic deformation of the upper end at the fastening portion of the rotor hub 21c when the force Fr intersecting with the center axis Cx is applied. As a result, the repeatable run-out (RRO) of the rotor 20 c can be reduced.

The peripheral wall portion 2173 of a lower recess 217c expands radially outward as proceeding axially downward. That is, the peripheral wall portion 2173 of the lower gap portion 62c has a tapered shape extending in a direction away from the contact surface between the shaft 10 and the through-hole 214 as proceeding axially downward. The peripheral wall portion 2173 has a tapered shape expanding axially downward. Since the lower end of the peripheral wall portion 2173 is distant from the contact surface between the shaft 10 and a rotor hub 21c, it is possible to suppress plastic deformation of the lower end at the fastening portion of the shaft 10 of the rotor hub 21c when the force Fr intersecting with the center axis Cx is applied. As a result, the repeatable run-out (RRO) of the rotor 20 c can be reduced.

In the second modification, both the peripheral wall portion 2163 of the upper gap portion 61c and the peripheral wall portion 2173 of the lower gap portion 62c are tapered, but at least one of them may be cylindrical in cross section with a constant inner diameter.

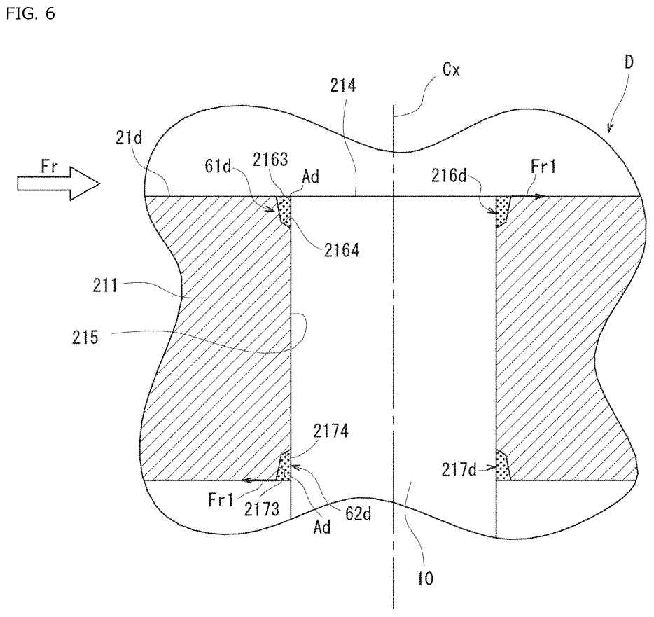

FIG. 6 is an enlarged sectional view of a motor D according to the third modification. In the motor D illustrated in FIG. 6, a bottom portion 2164 of an upper gap portion 61d and a bottom portion 2174 of a lower gap portion 62d are different from the bottom portion 2161 of the upper gap portion 61 and the bottom portion 2171 of the lower gap portion 62 of the motor A illustrated in FIG. 3 and the like. Regarding other points of the motor D, the motor D has the same configuration as that of the motor A illustrated in FIG. 3 and the like. Accordingly, a portion of the motor D which is substantially the same as that of the motor A is denoted by the same reference numeral, and duplicated detailed description of substantially the same portion will be eliminated.

As illustrated in FIG. 6, the bottom portion 2164 of the upper recess 216d is inclined axially upward as it goes radially outward. That is, the bottom portion 2164 of the upper gap portion 61d has a tapered shape extending in a direction away from the contact surface between the shaft 10 and the through-hole 214 as proceeding axially upward. The bottom portion 2164 has a tapered shape expanding axially upward. By forming the bottom portion 2164 into a tapered shape, the force acting in the direction orthogonal to the center axis Cx can be relaxed, and the plastic deformation of the upper end of the fastening portion of a rotor hub 21d to the shaft 10 can be suppressed. As a result, the repeatable run-out (RRO) of a rotor 20d can be reduced.

The bottom portion 2174 of a lower recess 217d is inclined radially outward as proceeding axially downward. That is, the bottom portion 2174 of the lower gap portion 62d has a tapered shape extending in a direction away from the contact surface between the shaft 10 and the through-hole 214 as proceeding axially downward. The bottom portion 2174 has a tapered shape expanding axially downward. By forming the bottom portion 2174 into a tapered shape, the force acting in the direction orthogonal to the center axis Cx can be relaxed, and the plastic deformation of the lower end of the fastening portion of a rotor hub 21d to the shaft 10 can be suppressed. As a result, the repeatable run-out (RRO) of a rotor 20d can be reduced.

In the third modification, both the peripheral wall portion 2163 of the upper gap portion 61c and the peripheral wall portion 2173 of the lower gap portion 62c are tapered, but one of them may be a surface orthogonal to the center axis Cx. In addition, the peripheral wall portions 2163 and 2173 each have a tapered shape but are not limited thereto, and at least one of the peripheral wall portions may have a cylindrical shape in cross section with a constant inner diameter.

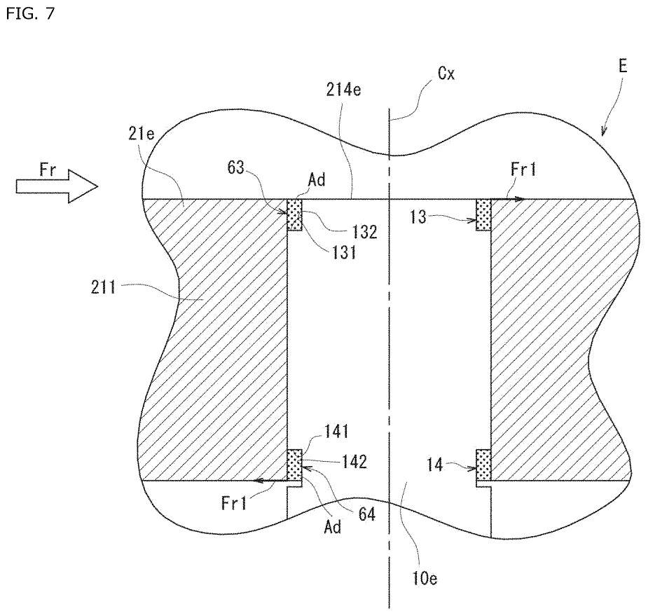

FIG. 7 is an enlarged sectional view of a motor E according to the fourth modification. In the motor E illustrated in FIG. 7, the upper gap portion 63 and the lower gap portion 64 are different from the upper gap portion 61 and the lower gap portion 62 of the motor A illustrated in FIG. 3 and the like. The shape of a through-hole 214e of a rotor hub 21e of the motor E is different from the shape of the through-hole 214 of the motor A. Regarding other points of the motor E, the motor E has the same configuration as that of the motor A illustrated in FIG. 3 and the like. Accordingly, a portion of the motor E which is substantially the same as that of the motor A is denoted by the same reference numeral, and duplicated detailed description of substantially the same portion will be eliminated.

As illustrated in FIG. 7, the rotor hub 21e has a through-hole 214e penetrating in the axial direction at the radial center of the hub top plate portion 211. A cross section taken along the center axis Cx of the through-hole 214e is a circular shape having a uniform inner diameter over the entire length in the axial direction.

An upper recessed groove 13 continuous in the circumferential direction is formed in the upper end portion of the opposing region Fs facing the through-hole 214e of the rotor hub 21e of a shaft 10e. The upper recessed groove 13 includes a bottom portion 131 disposed on the axially lower side and expanding in a direction intersecting the center axis Cx and a cylindrical peripheral wall portion 132 extending upward along the center axis Cx from a radial outer edge of the bottom portion 131. In the motor E, the upper gap portion 63 is formed at the upper end of the opposing region Fs.

A lower recessed groove 14 continuous in the circumferential direction is formed in a lower end portion of the opposing region Fs facing the through-hole 214e of the rotor hub 21e of the shaft 10e. The lower recessed groove 14 includes a bottom portion 141 disposed on the axially upper side and expanding in a direction intersecting the center axis Cx and a cylindrical peripheral wall portion 142 extending upward along the center axis Cx from a radial outer edge of the bottom portion 141. In the motor E, the lower gap portion 64 is formed at the lower end of the opposing region Fs.

That is, the peripheral wall portions 132 and 142 and the bottom portions 131 and 141 of at least one of the upper gap portion 63 and the lower gap portion 64 are formed on the shaft 10e. With this configuration, when the force Fr due to impact, vibration, or the like is applied in the direction intersecting the center axis Cx, plastic deformation of the upper end portion and the lower end portion of the opposing region of the rotor hub 21e can be suppressed. Since the plastic deformation of the rotor hub 21e is suppressed, it is possible to suppress an increase in repeatable run-out (RRO) generated in synchronization with the rotation of the shaft 10e. Since the upper gap portion 63 and the lower gap portion 64 have the bottom portions 131 and 141 and the peripheral wall portions 132 and 142, the axial lengths of the upper gap portion 63 and the lower gap portion 64 can be reduced. This can enlarge the fastening portion and firmly fix the rotor hub 21e to the shaft 10e.

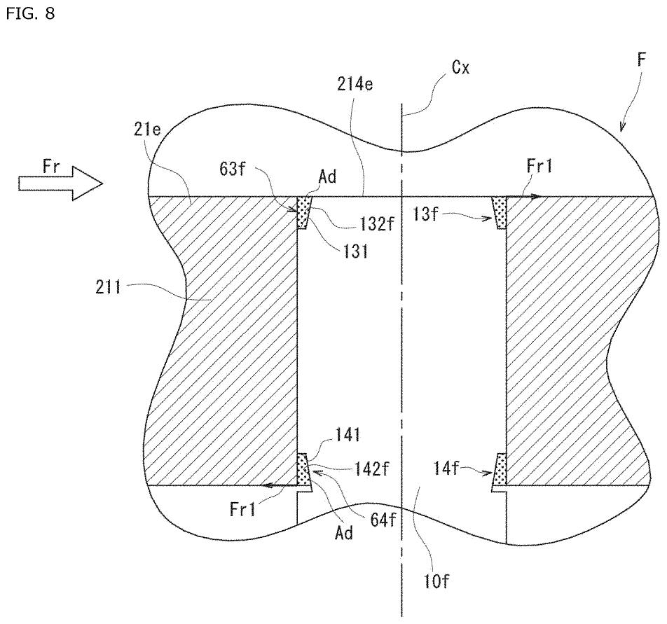

FIG. 8 is an enlarged sectional view of a motor F according to the fifth modification. In the motor F illustrated in FIG. 8, a peripheral wall portion 132f of an upper gap portion 63f and a peripheral wall portion 142f of a lower gap portion 64f of a shaft 10f are different from the peripheral wall portion 132 of the upper gap portion 63 and the peripheral wall portion 142 of the lower gap portion 64 of the motor E illustrated in FIG. 7 and the like. Regarding other points of the motor F, the motor F has the same configuration as that of the motor E illustrated in FIG. 7 and the like. Accordingly, a portion of the motor F which is substantially the same as that of the motor E is denoted by the same reference numeral, and duplicated detailed description of substantially the same portion will be eliminated.

As illustrated in FIG. 8, the peripheral wall portion 132f of an upper recessed groove 13f is inclined radially inward as it goes axially upward. That is, the peripheral wall portion 132f of the upper gap portion 63f has a tapered shape extending in a direction away from the contact surface between the shaft 10f and the through-hole 214e as proceeding axially upward. That is, the peripheral wall portion 132f has a tapered shape that narrows upward in the axial direction. Since the upper end of the peripheral wall portion 132f is distant from the contact surface between the shaft 10f and the through-hole 214e, it is possible to suppress plastic deformation of the upper end at the fastening portion of the rotor hub 21e when the force Fr intersecting with the center axis Cx is applied. As a result, the repeatable run-out (RRO) of a rotor 20f can be reduced.

The peripheral wall portion 142f of the lower recessed groove 14f is inclined radially inward as proceeding axially downward. That is, the peripheral wall portion 142f of the lower gap portion 64f has a tapered shape extending in a direction away from the contact surface between the shaft 10f and the through-hole 214e as proceeding axially downward. The peripheral wall portion 142f has a tapered shape that narrows downward in the axial direction. Since the lower end of the peripheral wall portion 142f is distant from the contact surface between the shaft 10f and a rotor hub 21e, it is possible to suppress plastic deformation of the lower end at the fastening portion of the shaft 10f of the rotor hub 21e when the force Fr intersecting with the center axis Cx is applied. As a result, the repeatable run-out (RRO) of a rotor 20f can be reduced.

In the fifth modification, both the peripheral wall portion 132f of the upper gap portion 63f and the peripheral wall portion 142f of the lower gap portion 64f are tapered, but at least one of them may be cylindrical in cross section with a constant inner diameter.

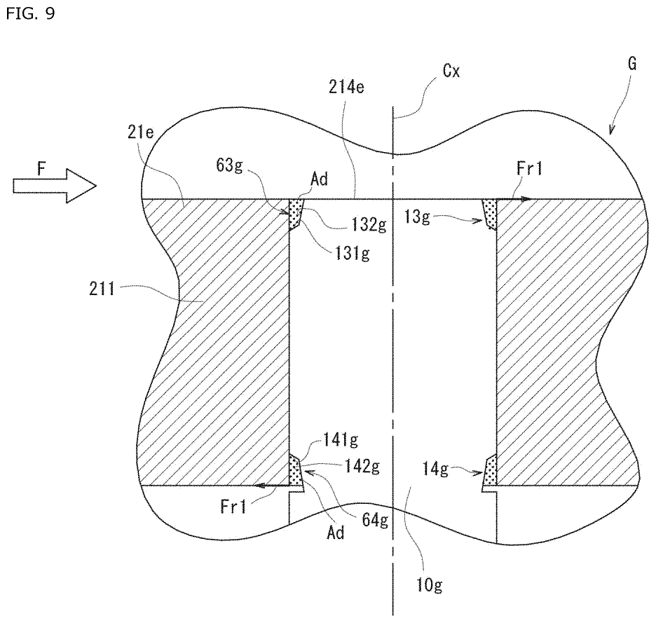

FIG. 9 is an enlarged sectional view of a motor G according to the sixth modification. In the motor G illustrated in FIG. 9, a bottom portion 131g of an upper gap portion 63g and a bottom portion 141g of a lower gap portion 64g are different from the bottom portion 131 of the upper gap portion 63f and the bottom portion 141 of the lower gap portion 64f of the motor F illustrated in FIG. 8 and the like. Other configurations of the motor F are the same as those of the motor F illustrated in FIG. 8 and the like. Accordingly, portions of the motor G which are substantially the same as those of the motor F are denoted by the same reference numerals, and a detailed description of the same portions will be eliminated.

As illustrated in FIG. 9, the bottom portion 131g of an upper recessed groove 13g is inclined axially upward as it goes radially inward. That is, the bottom portion 131g of an upper gap portion 63g has a tapered shape extending in a direction away from the contact surface between the shaft 10g and the through-hole 214e toward the axially upper side. The bottom portion 131g has a tapered shape that narrows axially upward. Tapering the bottom portion 131g makes it possible to alleviate the force acting in a direction orthogonal to the center axis Cx and suppress the plastic deformation of the upper end of the fastening portion of the rotor hub 21e to the shaft 10g. This can reduce the repeatable run-out (RRO) of the rotor 20d.

The bottom portion 141g of a lower recessed groove 14g is inclined radially inward as it goes axially downward. That is, the bottom portion 141g of the lower gap portion 64g has a tapered shape extending in a direction away from the contact surface between the shaft 10 and the through-hole 214 toward the axially lower side. The bottom portion 2174 has a tapered shape expanding axially downward. Tapering the bottom portion 141g makes it possible to alleviate the force acting in a direction orthogonal to the center axis Cx and suppress the plastic deformation of the lower end of the fastening portion of the rotor hub 21e to the shaft 10g. This can reduce the repeatable run-out (RRO) of the rotor 20d.

In the sixth modification, both the bottom portion 131g of the upper gap portion 63g and the bottom portion 141g of the lower gap portion 64g are tapered, but one of them may be a surface orthogonal to the center axis Cx. In addition, although the peripheral wall portions 132e and 142e are tapered, the present disclosure is not limited thereto, and at least one of the peripheral wall portions may be cylindrical in cross section with a constant inner diameter.

The present disclosure can be used as, for example, motors configured to drive storage devices such as hard disk devices and optical disk devices.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a shaft that extends along a center axis extending vertically and rotates around the center axis;
a rotor fixed to the shaft;
a bearing portion that rotatably supports the shaft; and
a stator radially opposing the rotor; wherein
the rotor includes a rotor hub with a through-hole to which the shaft is fixed;
an upper end and a lower end of an opposing region where an outer peripheral surface of the shaft and an inner peripheral surface of the through-hole oppose each other in a radial direction are respectively provided with an upper gap portion and a lower gap portion opposing each other through a space in the radial direction; and
the upper gap portion and the lower gap portion each include a bottom portion extending in a direction intersecting the center axis and a peripheral wall portion connected to a radial outer edge of the bottom portion and extending along the center axis.

2. The motor according to claim 1, wherein the peripheral wall portion and the bottom portion of at least one of the upper gap portion and the lower gap portion are located on the rotor hub.

3. The motor according to claim 1, wherein the peripheral wall portion and the bottom portion of at least one of the upper gap portion and the lower gap portion are located on the shaft.

4. The motor according to claim 1, wherein
at least one peripheral groove continuous in a circumferential direction is provided in at least one of the outer peripheral surface of the shaft and the inner peripheral surface of the through-hole below the upper gap portion and above the lower gap portion in the opposing region; and
the peripheral groove is filled with an adhesive.

5. The motor according to claim 1, wherein a sum of an axial length of the upper gap portion and an axial length of the lower gap portion is smaller than a length obtained by subtracting the axial length of the upper gap portion and the axial length of the lower gap portion of the opposing region from a length of the opposing region.

6. The motor according to claim 1, wherein at least one of the upper gap portion and the lower gap portion is filled with an adhesive.

7. The motor according to claim 6, wherein a radial length of an upper end of the upper gap portion is shorter than an axial length of the upper gap portion.

8. The motor according to claim 6, wherein a radial length of a lower end of the lower gap portion is shorter than an axial length of the lower gap portion.

9. The motor according to claim 1, wherein the peripheral wall portion of the upper gap portion has a tapered shape extending in a direction away from a contact surface between the shaft and the through-hole as proceeding axially upward.

10. The motor according to claim 1, wherein the peripheral wall portion of the lower gap portion has a tapered shape extending in a direction away from a contact surface between the shaft and the through-hole as proceeding axially downward.

11. The motor according to claim 1, wherein the bottom portion of the upper gap portion has a tapered shape extending in a direction away from a contact surface between the shaft and the through-hole as proceeding axially upward.

12. The motor according to claim 1, wherein the bottom portion of the lower gap portion has a tapered shape extending in a direction away from a contact surface between the shaft and the through-hole as proceeding axially downward.

13. A disk drive device comprising:
the motor according to claim 1; and
a disk support provided on the rotor hub to support a disk.
